(19) United States
(12) Patent Application Publication
(10) Pub. No.: US 2014/0319293 A1
(43) Pub. Date: Oct. 30, 2014

(54) COMPUTER MOUNTING DEVICE HAVING AN ARTICULATED COUNTERWEIGHT ARM

(71) Applicant: Myerchin Enterprises, Inc., Bellevue, WA (US)

(72) Inventor: Christian P. Myerchin, Bellevue, WA (US)

(73) Assignee: Myerchin Enterprises, Inc., Bellevue, WA (US)

(21) Appl. No.: 14/260,593

(22) Filed: Apr. 24, 2014

Related U.S. Application Data
(60) Provisional application No. 61/817,554, filed on Apr. 30, 2013.

(51) Int. Cl. G06F 1/16

(52) U.S. Cl. CPC G06F 1/1601
USPC 248/123.2

(57) ABSTRACT

A mounting base for a computer display device is disclosed having a counterweight that is coupled with one or more articulating arms configured to both maintain a center of mass of the base assembly with the display device to minimize a likelihood of toppling when the display device is pivoted outward about the base and to apply a counter torque to balance the display device when the display device is pivoted about the base.

### CROSS-REFERENCE TO RELATED APPLICATIONS

This application claims the benefit of U.S. Provisional Application Ser. No. 61/817,554 filed on Apr. 30, 2013, entitled “Computer Mounting Device Having An Articulated Counterweight Arm,” the benefit of the earlier filing date of which is hereby claimed under 35 U.S.C. §119 (e) and further incorporated by reference in its entirety.

### TECHNICAL INVENTION

Various embodiments, relate generally to computer display mounting devices, and more particularly, but not exclusively to a mounting base having an articulated counterweight useable for displays, such as touch screen displays, where the articulated counterweight is directed towards both maintaining a center of mass over the mounting base and controlling counter torque to the display at least during rotation of the display about the base.

### BACKGROUND

Electronic displays with data input capability may be considered as having two distinct usage modes. One usage mode is for information display, while a second usage mode is where a touch screen interaction and display are provided simultaneously. In the, first usage mode, the typical computer display involves a standard computer monitor, with an ergonomic design that encourages the display to be at a typical arm's length away from a user and at, or slightly below eye level. However, this position may not be ideal for the second usage mode where touching the screen is intended as a primary method of input. For the second usage mode, the display is often placed closer to the user, lower and in a more horizontal position than in a typical first usage mode. This can be accomplished by placing the display at the end of an arm and pivoting the arm from an elevated position to a lower position. However when this is done, it often moves the center of mass for the combined display and base to a point where the combination of base and display can topple. Thus, it is with respect to these considerations, and others, that embodiments of the present invention have been made.

### BRIEF DESCRIPTION OF THE DRAWINGS

Non-limiting and non-exhaustive embodiments are described with reference to the following drawings. In the drawings, like reference numerals refer to like parts throughout the various figures unless otherwise specified.

For a better understanding, reference will be made to the following Detailed Description, which is to be read in association with the accompanying drawings, wherein:

FIG. 1 illustrate perspective views of one embodiment of a base having a two arm counterweight arms with a computer display in various angled positions; and

FIG. 2 illustrates one non-limiting, non-exhaustive example of a graph of opposing torques at a fulcrum;

FIG. 3 illustrates one non-limiting, non-exhaustive example of a graph of a center of mass change as a display counterweight assembly is pivoted about fulcrum;

FIG. 4 illustrates another embodiment of a perspective view of arm and counterweight assembly where there are more than two locking arms in various angled positions; and

FIG. 5 illustrates another embodiment of a perspective view of two arm counterweight arms indirectly coupled with a computer display in various angled positions.

### DETAILED DESCRIPTION

Embodiments now will be described more fully hereinafter with reference to the accompanying drawings, which form a part hereof, and which show, by way of illustration, specific embodiments which may be practiced. This invention may, however, be embodied in many different forms and should not be construed as limited to the embodiments set forth herein; rather, these embodiments are provided so that this disclosure will be thorough and complete, and will fully convey the scope to those skilled in the art. The following detailed description is, therefore, not to be taken in a limiting sense.

Throughout the specification and claims, the following terms take the meanings explicitly associated herein, unless the context clearly dictates otherwise. References to “one embodiment,” “an embodiment,” “another embodiment,” as used herein indicates that a particular feature, structure, or characteristic described in connection with the embodiment is included in at least one embodiment. However, the phrase “in one embodiment” as used, herein does not necessarily refer to the same embodiment, though it may. Furthermore, the phrase “in another embodiment” as used herein does not necessarily refer to a different embodiment, although it may. Thus, as described below, various embodiments may be readily combined.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The following briefly describes the various embodiments in order to provide a basic understanding of some aspects of the invention. This brief description is not, intended as an extensive overview. It is not intended to identify key or critical elements, or to delineate or otherwise narrow the scope. Its purpose is merely to present some concepts in a simplified form as a prelude to the more detailed description that is presented later.

Briefly stated embodiments are directed towards a mounting base for a computer display device, the mounting base having a counterweight coupled with one or more articulating arms that are configured to both maintain a center of mass of the base assembly with the display device to minimize a likelihood of toppling when the display device is pivoted outward about the base and to apply a counter torque to balance the display device when the display device is pivoted about the base.

In one embodiment, a computer display is attached to a display mount that is pivotally connected to at least one display arm. The display arm(s) are pivotally connected to a mounting base. One or more counterweight(s) are attached to two or more counterweight arms, where the display and counterweight arms are pivotally connected to the base. The counterweight arms are pivotally connected in such a way that their pivot position will lock between free hanging to non-pivoting at predetermined angles. The display arm(s) and counterweight arms are coupled in such a way as to maintain the center of mass for the whole assembly (combined base, arms, display and counterweight) over the base and the display arm(s) and counterweight arms are coupled in such a way as to counterbalance each other's torque.

### PARTIAL LIST OF REFERENCE NUMERALS

10—Counterweight
11—Fulcrum Between Counterweight Arm and Display Arm
12—Cable
13—Display Arm
14—Display Mount
14a—Display Mount Curved Section
18—Display Arm Pivot Point at Display
19—Base (computer monitor base)
19a—Bottom Portion of Base 19
19b—Elevated Support Member of Base 19
20—Display
21—Base extend to cover area of maximum area of counterweight swing
25—First Counterweight Arm
25a—First Counterweight Arm, Outer Arm
25b—First Counterweight Arm, Inner Arm
27—Pivot Point Between First and Second Counterweight Arms
28—Locking Brace
30—Second Counterweight Arm
31—Second Counterweight Arm
32—Third Counterweight Arm
33—Fourth Counterweight Arm
35—Connectors for Outer Arms to Inner Arm
36—Display in Vertical Position
37—Display in Horizontal Position
38—Nut
40—Point(s) Where Display is Vertical
41—Point(s) Where Display is Horizontal
42—Point Where Second Counterweight Arm Locks
50—Display Arm Sprocket
51—Counterweight Arm Sprocket
52—Chain

### ILLUSTRATIVE EMBODIMENTS

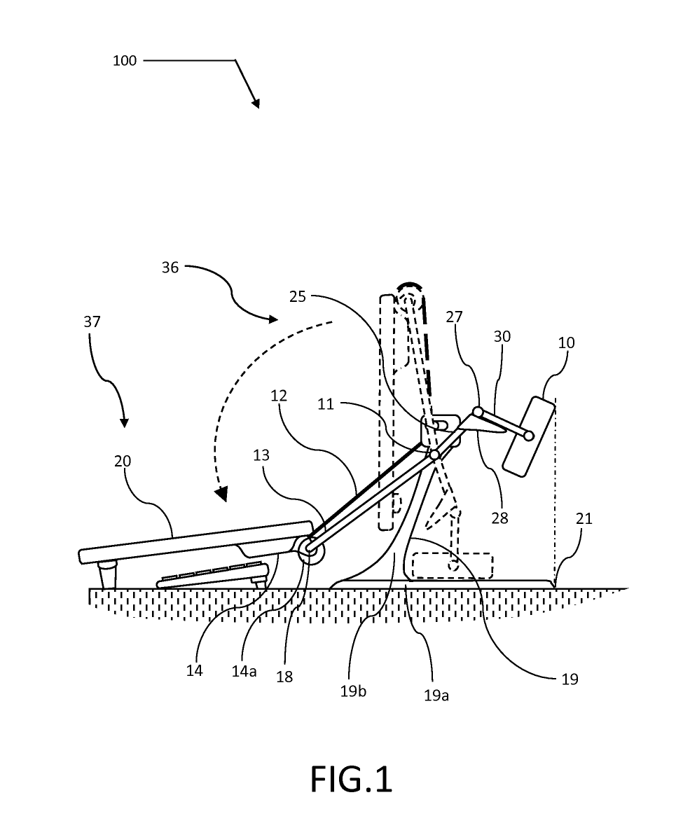

FIG. 1 illustrates perspective views of one embodiment of a computer monitor base assembly having an articulated counterweight with a computer display. As shown in FIG. 1, apparatus 100 includes base 19 with elevated fulcrum point 11. Base 19 may comprise bottom portion 19a and elevated support member 19b. Bottom portion 19a is configured for placement of apparatus 100 onto a surface, such as a desk. Fulcrum point 11 is attached to elevated support member 19b, which is arranged to elevate fulcrum point 11 above bottom portion 19a.

Base 19 may be formed of virtually any materials, including, but not limited to plastic, metal, a combination of plastic and metal, or the like. In one embodiment, elevated support member 19b and bottom portion 19a may be formed as a single unit, while in other embodiments, bottom portion 19a and elevated support member 19b may be configured as separable components, for shipping, storage, and/or other reasons. Moreover, in at least one embodiment, elevated support member 19b may be further configured as a telescopic component arranged to increase or decrease its height, to modify an overall height of base 19.

Fulcrum 11 may be rigidly attached to both first counterweight arm 25 and display arm 13; such that both first counterweight arm 25 and display arm 13 are pivotally connected to base 19 through fulcrum 11. First counterweight arm 25 is further attached to at least one second counterweight arm 30 at least at one pivot point 27. Locking brace 28 is rigidly attached to first counterweight arm 25. When the display is in vertical position 36 the second counter weight arm 30 hangs freely from pivot point 27. When the display is in the horizontal position 37 locking brace 28 supports the second counterweight arm 30 so that second counter weight arm 30 is prevented from pivoting at pivot point 27. Second counterweight arm 30 is further attached to at least one counterweight 10. Display arm 13 is pivotally coupled to display mount 14 at pivot point 18. Cable 12 connects to base 19. Cable 12 reaches to display mount 14. In one embodiment, cable 12 may be wrapped around and attached to curved section of display mount 14a, such that as display mount 14 rotates about pivot point 18, cable 12 ‘unwinds’ around a curved section of display mount 14a. A reverse rotation of display mount 14 similarly about pivot point 18 enables cable 12 to ‘wind’ around a curved section of display mount 14a.

Display mount 14 further attaches to a back of a display 20 at a second end of display mount 14. In one embodiment, display mount 14 is implemented as a rotatable arm, configured to rotate about display arm pivot point 18. FIG. 1 illustrates one display arm 13, one first counterweight arm 25, one second counterweight arm 30, and one counter weight 10; however, other embodiments may employ multiple arms and/or multiple counterweights. Moreover, in another embodiment, a single counterweight 10 may be connected by multiple arms.

Display 20 can be virtually any computer screen for providing an image to a user, including, but not limited to a monitor display, all-in-one computer, tablet computer or the like. In one embodiment, display 20 may be a computer display device that is configured as a touch screen display that enables users to interact and provide inputs to a computing system by touching a screen of the display 20. Display 20 may provide any of a variety of mechanisms for attaching to display mount 14, including, but not limited to bolts, screws, hooks, pin connectors, or the like. For example, in one embodiment a screw element may be employed to attach display 20 to display mount 14. By employing such mechanisms, display 20 may be removed from display mount 14 and/or other display devices may be attached to display mount 14. However, in other embodiments, display 20 may be attached to display mount 14 to not be readily removable. For example, in one embodiment, display 20 may be glued, soldered, welded, or otherwise permanently attached to display mount 14.

In one embodiment locking brace 28 is connected to first counter weight arm 25. However, other embodiments may attach the locking brace 28 to second counterweight arm 30 or both first counterweight arm 25 and second counterweight arm 30 may attach to portions of a locking brace. Furthermore in other embodiments, locking brace 28 may be pivotally attached to pivot point 27 and act as a spacer between the two arms 25 and 30. In one embodiment a single locking brace 28 is used to lock the pivoting action of the second counterweight arm 30. However, in other embodiments, multiple braces may be used to lock the pivoting action of multiple counterweight arms.

In one embodiment the locking brace 28 is permanently attached to first counterweight arm 25. However, in other embodiments, locking brace 28 may be detachable such that a different brace with a different locking point may be used. An adjustable locking point is useful to tune the torque imparted by the counterweight 10 or tune the center of mass adjusted by counterweight 10. In one embodiment the locking brace 28 is a non-adjustable bracket. However, in other embodiments, locking brace 28 may have an adjustable locking point. Methods of adjusting the locking point may include, but not limited to shims, screws, cams or the like.

In one embodiment counterweight 10 may be made of cast iron. Cast iron is typically inexpensive, heavy, non-toxic and durable. However, other embodiments may employ any of a variety of other materials for counterweight 10, including, but not limited to cast concrete, plate steal, lead or any other sufficiently dense material capable of withstanding light use and occasional accidental drops from a reasonable height, such as a desk, or the like.

By its nature, counterweight 10 is directed towards being sufficiently heavy to provide a counterweighing force to the weight of at least display 20, display mount 14, and display arm 13, to minimize a likelihood of apparatus 100 from tipping over when display 20 is pivoted between vertical 36 to horizontal 37. Therefore, counterweight 10 may add to a shipping cost of an embodiment. Thus, in some embodiments, counterweight 10 may be constructed to incorporate local materials after shipping. For example, counterweight 10 could be a hollow container filled with powered hydrogel, cement or some other solidifying agent such that water, sand, or some other Weighty substance, may be added as part of a user's assembly process.

In one embodiment, counterweight 10 may comprise a round cast iron disk attached to two second counterweight arms 30 using a pivoting coupling at the sides of the counter weight. In one embodiment, a single second counterweight arm 30 may have a threaded exterior and counterweight 10 may have threaded hole to accept second counterweight arm 30. In one embodiment, second counterweight arm 30 may be configured as a steel rod. The use of a threaded connection allows the counterweight to move back and forth relative to one end of second counterweight arm 30. This is useful for calibration of a balance between counterweight 10 and display 20. In another embodiments, counterweight 10 may be attached to the second arm(s) 30 via any of a variety of other methods, such as using two stoppers on either side of counterweight 10 to prevent the counterweight 10's movement along the length of second counterweight arm 30. Any of a variety of other methods that allows the user to adjust counterweight 10's position moved along a length of second counterweight arm 30 but held in a fixed position during normal use may also be employed.

Further, counterweight 10 may have any shape. For example, counterweight 10 may be a disc shape, ball shape, elongated shape, tubular shape, conic shaped, or the like. However, in at least one embodiment, selection of a shape might be made to have a center of mass for counterweight 10 as far away from the counterweight arm's fulcrum point 11 as possible. It is also possible to design a counterweight 10 and second counterweight arm 30 as a combined unit such that it may be formed as a single object. For example, a counterweight and arm may be constructed of a single cast iron component. However, as noted elsewhere, other materials may also be used.

In other embodiments, the mass of the counterweight 10 may be adjusted by replacing the weight or adding/removing pieces to/from it. This feature is useful if display 20 is sold separately from the rest of the assembly and the user is required to calibrate the balance between a counterweight and display 20.

In other embodiments the second counterweight arm 30 may attach to pivot point 27 via a detachable hook or clasp. This feature is useful for shipment of the assembly 100 or as a method for the user to quickly change the counter weight 10.

In one embodiment the lower base 19a is extended behind the display 20 to cover the horizontal space of the fully extended counterweight above 21. The function of the extension is to allow the base 19a to be placed in contact with a vertical surface, such as a wall. Assembly 100 can be operated next to the adjacent to vertical surfaces and the counterweight will not contact the vertical surfaces because the extended display base 19a prevents this. In one embodiment the extended base is a single piece of rigid material. In other embodiments, as shown in later figure, the display lower base 19a may have a detachable extension.

### Illustrative Operations

The operation of certain aspects of the embodiments will now be described with respect to FIG. 1. FIG. 1 illustrates perspective view of one embodiment of a base having a counterweight with a computer display in various angled positions. As illustrated, the display 20 in vertical position 36; the display 20 in horizontal position 37. It should be readily apparent to one of skill in the art that such illustrated positions are non-limiting, and other positions may be obtained when the computer display is rotated about the base, as described further below.

In any event, when display 20 is in vertical position 36 (as shown in FIG. 1 via the dashed components), the display 20 is in its highest elevation, and counterweight 10 is below display 20, and is at its lowest elevation. As used herein, the term “vertical” with respect to display 20 refers to a screen viewing face of display 20 that is used to display images or other content, being vertical or approximately vertical within a few degrees of tolerance from a 90 degrees position with respect to a desk, or other surface upon which base 19 with display 20 is placed. When in the vertical position 36 the second counterweight arm hangs below pivot point 27, the position of second counterweight arm 30 and counterweight 10 is aligned relative to the pull of gravity. Again, vertical position 36, illustrates one embodiment of such vertical configuration.

As shown in FIG. 1, as display arm 13 is lowered (see dashed arrow indicating direction of movement), such as being repositioned downwards towards a resting surface like a desk or the like, first counterweight arm 25 is reciprocally raised because of a rigid connection between first counterweight arm 25 and display arm 13. The second counterweight 30 arm will hang from pivot point 27 until the locking brace 28 comes into contact against second counterweight arm 30. At this point pivot position of the second counterweight arm 30 and the counterweight 10 will be locked in reference to the first counterweight arm 25.

In addition, as display arm 13 is lowered, the distance between cable 12 attachment points to the base 19 and the display mount 14 will increase. The increase in distance will cause cable 12 to unwind around curved section of display mount 14a. This will impart a torque on display mount 14, forcing display mount 14 to rotate around display pivot point 18 and to tilt display mount 14 away from base 19.

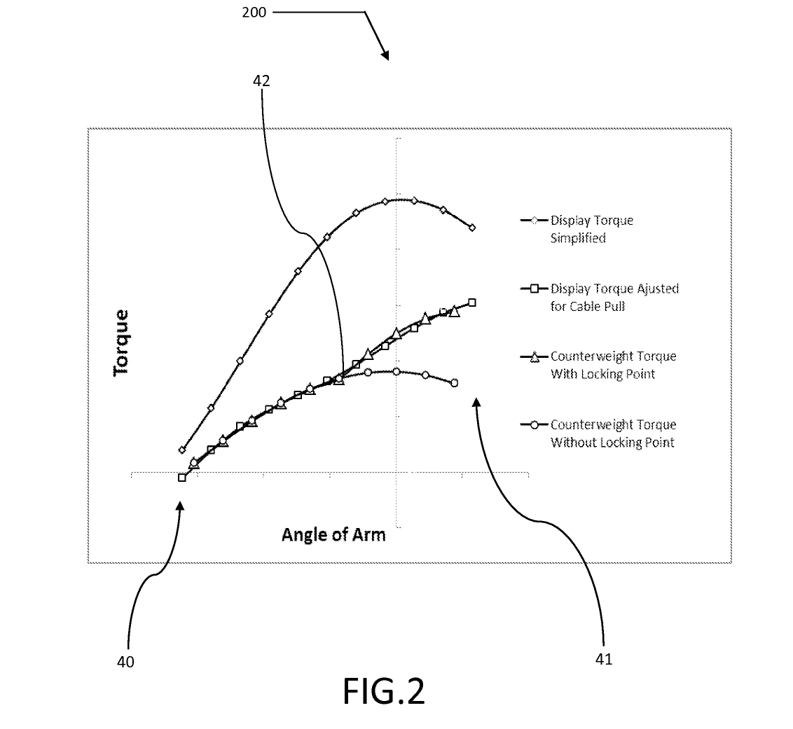

In one embodiment, the torque forces at the fulcrum 11 can be approximated to the sum of the display torque (e.g. display assembly center of mass multiplied by the distance from fulcrum 11 and the torque exerted by pull of cable 12 against curved section of display mount 14a), the counter weight torque (e.g. the counterweight assembly center of mass multiplied by distance from fulcrum 11). FIG. 2 provides one non-limiting, non-exhaustive example of a graph 200 of the torques exerted at fulcrum 11. Graph 200 shows an evident point of deflection 42 in the line “Counterweight Toque With Locking Point” when the second counterweight arm 30 contacts locking brace 28. By comparing line “Counterweight Toque With Locking Point” with line “Display Torque Adjusted for Cable Pull” it is evident that the locking brace 28 allows the counterweight torque to closely match the display torque. When the torques match the display arm 13 may be considered in balance with first counterweight arm 25, the display will neither rise or fall left when in static motion. When the torques are balanced only a small force is required to change the display 20 position and if the display 20 is stopped in between vertical 36 and horizontal 37 positions the display 20 will maintain its position.

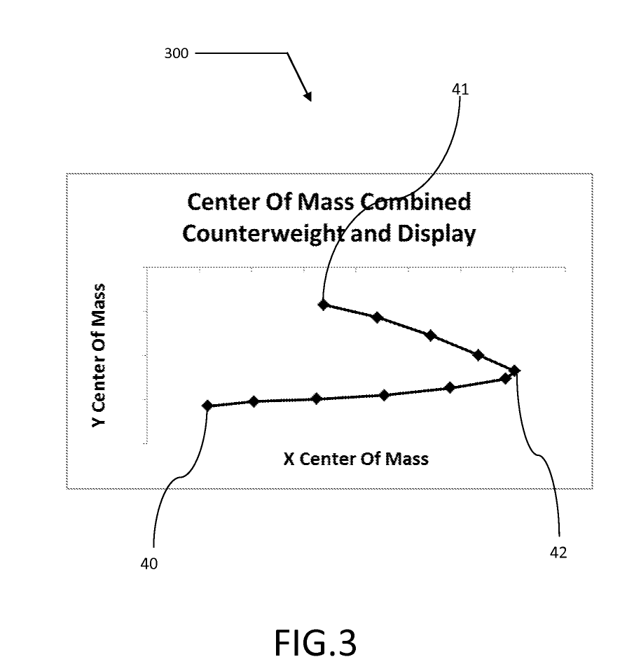

In one embodiment, the center of mass for assembly 100 can be approximated to is the sum of display assembly center of mass (including a sum of masses of at least display 20, display arm 13, and display mount 14) and the counterweight assembly center of mass (including a sum of masses of at least counterweight 10, first counterweight arm 25, locking brace 28 and second counter weight arm 30) and the base 19 center of mass. FIG. 3 provides one non-limiting, non-exhaustive example of a graph 300 for the change in the center of mass for assembly 100 as the display 20 pivots between vertical 40 to horizontal 41. Graph 300 shows show an evident point of deflection 42 when the second counterweight arm 30 contacts locking brace 28. When assembly 100 has reached point 42 the counterweight 10 will swing a wider arc around fulcrum 11 thus affecting the center of mass. Provided the center of mass for the assembly 100 does not extend beyond edge of lower base 19a the assembly 100 should not topple.

### ALTERNATIVE EMBODIMENTS

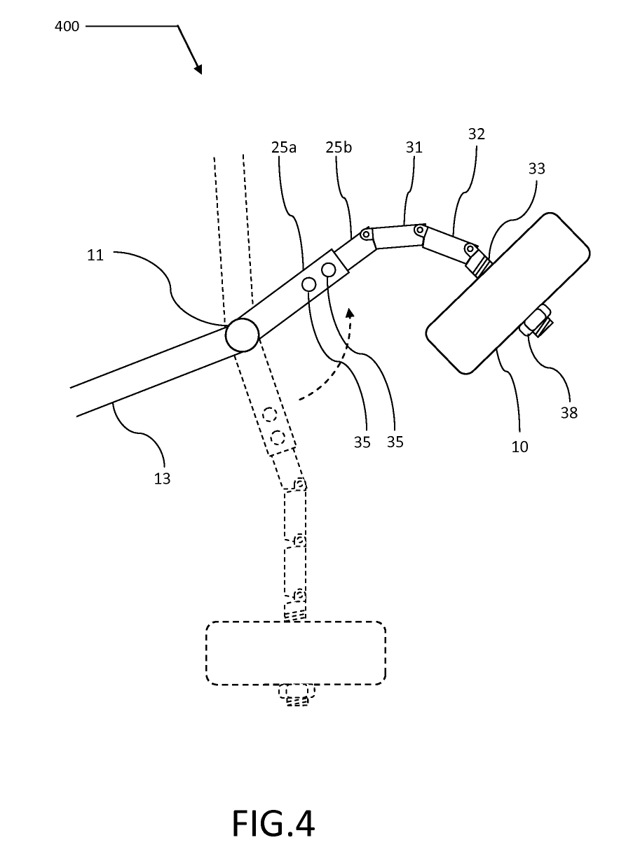

Other embodiments are also envisaged. For example, FIG. 4 illustrates one embodiment of a perspective view of a counterweight arm configuration where at least three articulated locking arms are used. Apparatus 400 of FIG. 4 does not show base and display illustrations. Display arm 13 and first outer counterweight arm 25a are rigidly coupled to fulcrum 11. First outer counterweight arm 25a is rigidly coupled to first inner counterweight arm 25b by connectors 35. In one embodiment, two outer counterweight arms 25a are positioned on either side the base and the first inner counterweight arm 25b is centered between the outer counterweight arms 25a. In one embodiment connectors 35 may be threaded steel round rod, glued fiberglass, or any other material sufficiently rigid to prevent defection between the outer arm 25a and inner arm 25b.

First inner counterweight arm 25b is further pivotally attached to second counterweight arm 31. In a similar manner second counterweight arm 31 is pivotally attached to third counterweight arm 32 and third counterweight arm 32 is pivotally attached to fourth counterweight arm 33. Counterweight arms 25b, 31, 32, and 33 are constructed to allow pivoting movement between adjacent arms for range of angles but at a given angle the adjacent arms will touch and prevent any further pivoting in that direction of rotation.

Fourth counterweight arm 33 is connected to counter weight 10. In one embodiment, fourth counterweight arm 33 is threaded and inserted through the center of counterweight 10; a nut 38 is threaded into fourth counterweight arm 33 to prevent counterweight 10 sliding off fourth counterweight arm 33. In other embodiments the counterweight 10 may be secured by clips, pins or other method capable of restricting the counterweights movement.

In one embodiment of apparatus 400, the counterweight arms 31, 32, and 33 may be permanently attached to each other. In other embodiments the counterweight arms may be detachable so that other arms may be added or removed to change the torque or center of mass configuration.

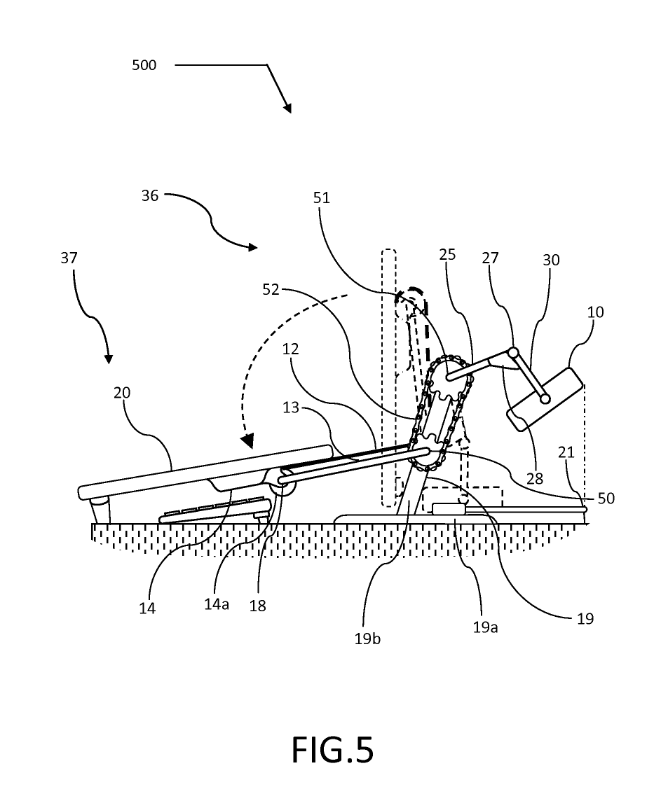

FIG. 5 illustrates another embodiment of a perspective view of a base 19 having a mounted computer display 20 where display arm 13 is indirectly coupled to a counterweight arm 25 by a chain 52 and sprocket mechanism. Apparatus 500 of FIG. 5 shows base 19 where display arm sprocket 50 is rigidly connected to display arm 13 likewise counterweight sprocket 51 is rigidly connected to first counterweight arm 25. A chain 52 wraps display arm sprocket 50 and counterweight sprocket 51. When display arm 13 moves from the vertical position 36 to horizontal position 37 is the first counter weight arm 25 is moved in a counter rotational manner. In one embodiment the pivot points for the display arm 13 and first counterweight arm 25 are connected to sprockets and wrapped by a chain 52. In other embodiments, the pivot points of the display arm 13 and first counterweight arm 25 may be attached to gears, rollers, pulleys and belts, cams and cable or any other mechanism capable of providing an indirect method of coupling the pivotal motion of the display arm 13 to the first counterweight arm 25.

The above specification, examples, and data provide a complete description of the manufacture and use of the composition various embodiments. Since many embodiments of the invention can be made without departing from the spirit and scope of the invention, the invention resides in the claims hereinafter appended.

What is claimed as new and desired to be protected by Letters Patent of the United States is:

1. An apparatus usable to support a computer display device, the apparatus comprising:
a base having a bottom portion and an attached elevated support member;
a display arm having a first end that is pivotally connected to the elevated support member; and
two or more counterweight arms with a first counterweight arm having a first end that is pivotally connected to the elevated support member so that when the display arm is pivoted about the base, the first counterweight arm pivots about the base, and wherein a first end of a second counterweight arm is pivotally connected to the second end of the first counterweight arm, wherein a second counterweight arm pivot angle is blocked for a portion of its range to maintain a center of mass of the apparatus over the base and minimize a likelihood that the apparatus becomes unbalanced.

2. The apparatus of claim 1, wherein a third counterweight arm having a same function as the second counterweight arm is sequentially connected pivotally to the second counterweight arm at a second end of the second counterweight arm.

3. The apparatus of claim 2, wherein a fourth counterweight arm having a same function as the third counterweight arm is sequentially connected pivotally to the third counterweight arm at a second end of the third counterweight arm.

4. The apparatus of claim 3 wherein each of the counterweight arms are constructed to allow pivoting movement between adjacent arms for a defined range of angles but at a given angle the adjacent arms are configured to prevent further pivoting in a given direction of rotation.

5. The apparatus of claim 1, wherein a torque of the first counterweight arm contracts a torque of the display arm providing an approximate balance between the counter weight arms and the display arm.

6. The apparatus of claim 1, wherein when the display device attached to the second end of the display arm is in a vertical position, the second counterweight arm is configured to hang freely from its respective pivot point on the elevated support member, and when the display device is in an horizontal position, a locking brace is arranged that supports the second counterweight arm so that second counterweight arm is prevented from pivoting at its respective pivot point.

7. The apparatus of claim 1, wherein a counterweight is removably affixed to a second end of a counterweight arm that is furthest from the first counterweight arm in the sequence of counterweight arms.

8. A device usable to support a computer display device, the device comprising:
a base having a bottom portion and an attached elevated support member;
a display arm having a first end that is pivotally connected to the elevated support member;
two or more counterweight arms with a first arm having a first end that is pivotally connected to the elevated support member so that when the display arm is pivoted about the base, the first counterweight arm pivots about the base; and
a first end of a second counterweight arm that is pivotally connected to the second end of the first counterweight arm, wherein the second counterweight arm pivot angle is blocked for a portion of its range.

9. The device of claim 8, wherein an additional counterweight arm having the same function as the second counterweight arm is sequentially added.

10. The device of claim 8, wherein a torque of the first counterweight arm contracts a torque of the display arm providing an approximate balance between the arms.

11. The device of claim 8, wherein each of the counterweight arms are constructed to allow pivoting movement between adjacent arms for a defined range of angles but at a given angle the adjacent arms are configured to prevent further pivoting in a given direction of rotation.

12. The device of claim 8, wherein a counterweight is removably affixed to a second end of an outermost counterweight arm in a sequence of counterweight arms.

13. The device of claim 8, the device further comprising;
a locking brace that is rigidly attached to the first counterweight such that when the display device is in a vertical position, the second counterweight arm hangs freely from its respective pivot point with respect to its first end, and when the display device is in an horizontal position, the locking brace is configured to support the second counterweight arm so that the second counterweight arm is prevented from pivoting at its respective pivot point with respect to its first end.

14. The device of claim 8, further comprising:
a cable that is connected to the elevated support member, and is connected at a first end of the cable to a second end of the display arm, the second end having a curved section, such that when the display arm rotates about a pivot point, the cable unwinds around the curved section of the display arm.

15. A system usable to support a computer display device, the device comprising:
a base having a bottom portion and an attached elevated support member;
a display arm having a first end that is pivotally connected to the elevated support member;
two or more counterweight arms with a first arm having a first end that is pivotally connected to the elevated support member so that when the display arm is pivoted about the base, the first counterweight arm pivots about the base; and
a first end of a second counterweight arm that is pivotally connected to the second end of the first counterweight arm, wherein the second counterweight arm pivot angle is blocked for a portion of its range.

16. The system of claim 15, wherein an additional counterweight arm having the same function as the second counterweight arm is sequentially added.

17. The system of claim 15, wherein a torque of the first counterweight arm contracts a torque of the display arm providing an approximate balance between the arms.

18. The system of claim 15, wherein each of the counterweight arms are constructed to allow pivoting movement between adjacent arms for a defined range of angles but at a given angle the adjacent arms are configured to prevent further pivoting in a given direction of rotation.

19. The system of claim 15, wherein a removable counterweight is removably affixed to a second end of an outermost counterweight arm in a sequence of counterweight arms.

20. The system of claim 15, the system further comprising:
a locking brace that is rigidly attached to the first counterweight such that when the display device is in a vertical position, the second counterweight arm hangs freely from its respective pivot point with respect to its first end, and when the display device is in an horizontal position, the locking brace is configured to support the second counterweight arm so that the second counterweight arm is prevented from pivoting at its respective pivot point with respect to its first end.
